(19) United States
(12) Patent Application Publication
(10) Pub. No.: US 2007/0135556 A1
(43) Pub. Date: Jun. 14, 2007

(54) Coating materials containing alpha-(1'-hydroxyalkyl)acrylates

(76) Inventors: Reinhold Schwalm, Wachenheim (DE); Erich Beck, Ladenburg (DE); Yvonee Heischkel, Mannheim (DE); Nick Gruber, Mannheim (DE); Harald Larbig, Ludwigshafen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/581,688

(22) PCT Filed: Dec. 8, 2004
(86) PCT No.: PCT/EP04/13948

§ 371 Date: Jun. 6, 2006

(30) Foreign Application Priority Data
Dec. 10, 2003 (DE) 103 58 081.6

(51) Int. Cl. C09B 67/00

(52) U.S. Cl. 524/502

(57) ABSTRACT

Coating compositions comprising α-(1′-hydroxyalkyl)acrylates, processes for preparing them, and their use.

The present invention relates to coating compositions comprising α-(1′-hydroxyalkyl)-acrylates, to processes for preparing them, and to their use.

α-(1′-Hydroxyalkyl)acrylates are preparable via the Baylis-Hillman reaction, in which acrylates and aldehydes are reacted with one another.

U.S. Pat. No. 5,380,901 describes the reaction of acrylates with para-formaldehyde to form ether-bridged diacrylates and the reaction of diacrylates with formaldehyde to form di(α-(1′-hydroxyalkyl))acrylates and also the potential use of such monomers in, for example, coatings. As curing only bulk polymerization is described.

US-B1 6,482,568 describes resin compositions for photoresists which can be radiation-cured by excimer laser, which are composed of specific norbornene derivative monomers and which can include as further monomers in copolymerized form, optionally, α-hydroxymethyl acrylates.

The specific resin compositions described therein are likewise prepared only by bulk polymerization and the polymerized resins are designed only for curing with defined wavelengths in lithography and cannot be employed broadly.

It was an object of the present invention to develop new coating compositions for radiation curing and particularly for multicure applications.

The object has been achieved by means of coating compositions comprising
at least one α-(1′-hydroxyalkyl)acrylate (A) and
at least one photoinitiator (P).

The terms “dual cure” or “multicure” refers for the purposes of this specification to a curing process which takes place via two or more than two mechanisms selected in particular, for example, from radiation, moisture, chemical, oxidative and/or thermal curing, preferably selected from radiation, moisture, chemical and/or thermal curing, more preferably selected from radiation, chemical and/or thermal curing and very preferably radiation and chemical curing.

Radiation curing for the purposes of this specification is defined as the polymerization of polymerizable compounds as a consequence of electromagnetic and/or corpuscular radiation, preferably UV light in the wavelength range λ=200 to 700 nm and/or electron beams in the range from 150 to 300 keV and more preferably with a radiation dose of at least 80, preferably from 80 to 3000, mJ/cm².

Chemical curing for the purposes of this specification is defined as the polymerization of polymerizable compounds as a consequence of reaction of hydroxyl groups (—OH) with hydroxyl (—OH)-reactive groups, examples being isocyanates, including blocked isocyanates, epoxides, carbonates or amino resins, preferably isocyanates, epoxides or amino resins, more preferably isocyanates or epoxides and very preferably isocyanates.

Suitable α-(1′-hydroxyalkyl)acrylates (A) may carry one or more, for example, 1 to 10, preferably 1 to 6, more preferably 1 to 4, very preferably 2 to 4 and in particular 3 or 4 α-(1 ′-hydroxyalkyl)acrylate groups.

The number average molecular weight Mₙ, of these compounds (A), determined by gel permeation chromatography using tetrahydrofuran as eluent and polystyrene as standard, can be, for example, up to 10 000, preferably up to 5000, more preferably between 100 and 2000 and in particular between 100 and 1000 g/mol.

Examples of such α-(1′-hydroxyalkyl)acrylates (A) are compounds obtainable by reacting a monofunctional or polyfunctional acrylate with a monofunctional or polyfunctional carbonyl compound.

Examples of carbonyl compounds are aldehydes or ketones, preferably aldehydes.

The reaction in question may be that of a monofunctional acrylate (I) with a monofunctional carbonyl group (II).

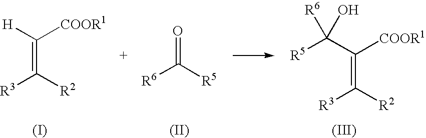

It may also be the reaction of a polyfunctional acrylate (IV) with a monofunctional carbonyl compound (II).

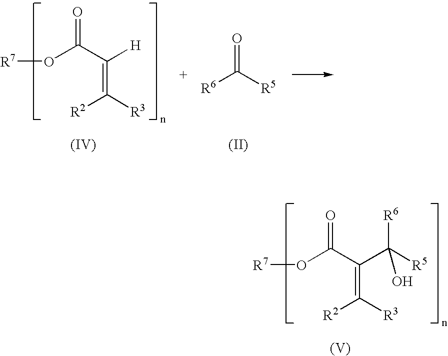

It may further be the reaction of a polyfunctional acrylate (I) with a polyfunctional carbonyl group (VI). 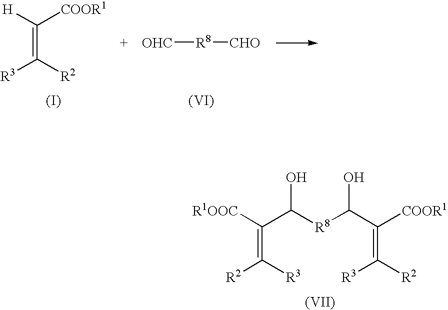
In these formulae
R¹, R² und R³ independently of one another are C₁-C₁₈ alkyl, C₂-C₁₈ alkyl optionally interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered, oxygen-, nitrogen- and/or sulfur-containing heterocycle, it being possible for each of the stated radicals to be substituted by aryl, alkyl, aryloxy, alkyloxy, heteroatoms and/or heterocycles,
R² and/or R³ are additionally hydrogen, C₁-C₁₈ alkoxy which is optionally substituted by aryl, alkyl, aryloxy, alkyloxy, heteroatoms and/or heterocycles, or —COOR⁴,
R² may additionally together with R¹ form a ring, in which case R² can be a carbonyl group, so that the groups COOR¹ and R² together form an acid anhydride group —(CO)—O—(CO)—,
R⁴ has the same definition as given for R¹, but may be different from R¹,
R⁵ and R⁶ independently of one another are hydrogen, C₁-C₁₈ alkyl, C₂-C₁₈ alkyl optionally interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered, oxygen-, nitrogen- and/or sulfur-containing heterocycle, it being possible for each of the stated radicals to be substituted by aryl, alkyl, aryloxy, alkyloxy, heteroatoms and/or heterocycles, or may together form a ring,
n is a positive integer from 2 to 10,
R⁷ is an n-valent organic radical having 1 to 50 carbon atoms which can be unsubstituted or substituted by halogen, C₁-C₈ alkyl, C₂-C₈ alkenyl, carboxyl, carboxy-C₁-C₈ alkyl, C₁-C₂₀ acyl, C₁-C₈ alkoxy, C₆-C₁₂ aryl, hydroxyl or hydroxy-substituted C₁-C₈ alkyl and/or can contain one or more —(CO)—, —O(CO)O—, —(NH)(CO)O—, —O(CO)(NH)—, —O(CO)— or —(CO)O— groups, and
R⁸ is unsubstituted or halogen-, C₁-C₈ alkyl-, C₂-C₈ alkenyl-, carboxyl-, carboxy-C₁-C₈ alkyl-, C₁-C₂₀ acyl-, C₁-C₈ alkoxy-, C₆-C₁₂ aryl-, hydroxyl- or hydroxy-substituted C₁-C₈ alkyl-substituted C₆-C₁₂ arylene, C₃-C₁₂ cycloaokylene or C₁-C₂₀ alkylene or is C₂-C₂₀ alkylene interrupted by one or more oxygen and/or sulfur atoms and/or one or more substituted or unsubstituted imino groups and/or by one or more —(CO)—, —O(CO)O—, —(NH)(CO)O—, —O(CO)(NH)—, —O(CO)— or —(CO)O— groups or is a single bond.

In these definitions

C₁-C₁₈ alkyl optionally substituted by aryl, alkyl, aryloxy, alkyloxy, heteroatoms and/or heterocycles is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetra-methylbutyl, benzyl, 1-phenylethyl, 2-phenylethyl, α,α-dimethylbenzyl, benzhydryl, p-tolylmethyl,1-(p-butylphenyl)ethyl, p-chlorobenzyl, 2,4-dichlorobenzyl, p-methoxy-benzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, 2-chloroethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylthioethyl, 2,2,2-trifluoro-ethyl, 2-hydroxyethyl, 2-hydroxypropyl, 3-hydroxypropyl, 4-hydroxybutyl, 6-hydroxy-hexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylamino-propyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl,

C₁-C₁₈ alkoxy optionally substituted by aryl, alkyl, aryloxy, alkyloxy, heteroatoms and/or heterocycles is for example methoxy, ethoxy, n-propyloxy, isopropyloxy, n-butyloxy, isobutyloxy, sec-butyloxy, tert-butyloxy, 6-hydroxy-1,4-dioxohexyl, 9-hydroxy-1,4,7-trioxononyl, 12-hydroxy-1,4,7,10-tetraoxododecyl, 6-methoxy-1,4-dioxohexyl, 9-methoxy-1,4,7-trioxononyl, 12-methoxy-1,4,7,10-tetraoxododecyl, 6-ethoxy-1,4-dioxohexyl, 9-ethoxy-1,4,7-trioxononyl, 12-ethoxy-1,4,7,10-tetraoxododecyl, 8-hydroxy-1,5-dioxooctyl, 12-hydroxy-1,5,9-trioxooctyl, 16-hydroxy-1,5,9,13-tetra-oxohexadecyl, 8-methoxy-1,5-dioxooctyl, 12-methoxy-1,5,9-trioxooctyl, 16-methoxy-1,5,9,13-tetraoxohexadecyl, 8-ethoxy-1,5-dioxooctyl, 12-ethoxy-1,5,9-trioxooctyl, 16-ethoxy-1,5,9,13-tetraoxohexadecyl, 10-hydroxy-1,6-dioxodecyl, 15-hydroxy-1,6,11-trioxopentadecyl, 10-methoxy-1,6-dioxodecyl, 15-methoxy-1,6,11-trioxo-pentadecyl, 10-ethoxy-1,6-dioxodecyl or 15-ethoxy-1,6,11-trioxopentadecyl,

C₂-C₁₈ alkyl optionally interrupted by one or more oxygen and/or sulfur atoms and/or one or more substituted or unsubstituted imino groups is for example 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8, 12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxa-nonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxa-tetradecyl.

There is no limit on the number of oxygen and/or sulfur atoms and/or imino groups. In general the number is not more than 5 in the radical, preferably not more than 4 and very preferably not more than 3.

Additionally there is generally at least one carbon atom, preferably at least two, present between two heteroatoms.

Substituted and unsubstituted imino groups can be, for example, imino, methylimino, isopropylimino, n-butylimino or tert-butylimino.

Additionally

C₂-C₁₈ alkenyl optionally substituted by aryl, alkyl, aryloxy, alkyloxy, heteroatoms and/or heterocycles is for example vinyl, 1-propenyl, allyl, methallyl, 1,1-dimethylallyl, 2-butenyl, 2-hexenyl, octenyl, undecenyl, dodecenyl, octadecenyl, 2-phenylvinyl, 2-methoxyvinyl, 2-ethoxyvinyl, 2-methoxyallyl, 3-methoxyallyl, 2-ethoxyallyl, 3-ethoxy-allyl or 1- or 2-chlorovinyl,

C₆-C₁₂ aryl optionally substituted by aryl, alkyl, aryloxy, alkyloxy, heteroatoms and/or heterocycles is for example phenyl, tolyl, xylyl, α-naphthyl, β-naphthyl, 4-biphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methyinaphthyl, isopropyinaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl,

C₅-C₁₂ cycloalkyl optionally substituted by aryl, alkyl, aryloxy, alkyloxy, heteroatoms and/or heterocycles is for example cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl and also a saturated or unsaturated bicyclic system such as norbornyl or norbornenyl for example,

a five- to six-membered, oxygen-, nitrogen- and/or sulfur-containing heterocycle is for example furyl, thiophenyl, pyrryl, pyridyl, indolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl, and

C₁ to C₄ alkyl is for example methyl, ethyl, propyl, isopropyl, n-butyl, sec-butyl or tert-butyl.

There is no restriction on the number of substituents in the radicals specified. In general the number, in the case of radicals having one to three carbon atoms, is up to 3 substituents, preferably up to 2 and more preferably up to one. In the case of radicals having four to six carbon atoms it is generally up to 4 substituents, preferably up to 3 and more preferably up to one. In the case of radicals having more than seven carbon atoms it is generally up to 6 substituents, preferably up to 4 and more preferably up to two.

R¹ is preferably aryl-, alkyl-, aryloxy-, alkyloxy-, heteroatom- and/or heterocycle-substituted C₁-C₁₈ alkyl or C₅-C₁₂ cycloalkyl, examples being methyl, ethyl, propyl, isopropyl, n-butyl, sec-butyl, tert-butyl, pentyl, hexyl, heptyl, octyl, 2-ethylhexyl, 2-hydroxyethyl, 2-hydroxypropyl, 3-hydroxypropyl, 4-hydroxybutyl, 6-hydroxyhexyl, cyclopentyl, cyclohexyl, cyclooctyl, cyclododecyl, methylcyclopentyl, dimethylcyclopentyl, methylcyclohexyl, dimethylcyclohexyl, norbornyl or norbornenyl; more preferably R¹ is methyl, ethyl, propyl, isopropyl, n-butyl, sec-butyl, tert-butyl, pentyl, hexyl, heptyl, octyl, 2-ethylhexyl, 2-hydroxyethyl, 2-hydroxypropyl, 3-hydroxy-propyl, 4-hydroxybutyl or 6-hydroxyhexyl; very preferably methyl, ethyl, propyl, isopropyl, n-butyl, sec-butyl, tert-butyl or 2-ethylhexyl, and in particular methyl, ethyl, n-butyl or 2-ethylhexyl.

R² is preferably hydrogen, aryl-, alkyl-, aryloxy-, alkyloxy-, heteroatom- and/or heterocycle-substituted C₁-C₁₈ alkyl or a carbonyl group connected to R¹, so that the groups COOR¹ and R² together form an acid anhydride group —(CO)—O—(CO)—, more preferably hydrogen, methyl, ethyl, propyl, isopropyl, n-butyl, sec-butyl or tert-butyl, very preferably hydrogen or methyl and in particular hydrogen.

R³ is preferably hydrogen, aryl-, alkyl-, aryloxy-, alkyloxy-, heteroatom- and/or heterocycle-substituted C₁-C₁₈ alkyl, more preferably hydrogen, or C₁-C₄ alkyl, by which for the purposes of this specification is meant methyl, ethyl, propyl, isopropyl, n-butyl, sec-butyl or tert-butyl, very preferably hydrogen or methyl and in particular hydrogen.

R⁴ is preferably methyl, ethyl, propyl, isopropyl, n-butyl, sec-butyl or tert-butyl, more preferably methyl or ethyl.

R⁵ and R⁶ are independently of one another preferably hydrogen, aryl-, alkyl-, aryloxy-, alkyloxy-, heteroatom- and/or heterocycle-substituted C₁-C₁₈ alkyl, C₂-C₁₈ alkenyl, C₆-C₁₂ aryl or C₅-C₁₂ cycloalkyl, more preferably hydrogen, aryl-, alkyl-, aryloxy-, alkyloxy-, heteroatom- and/or heterocycle-substituted C₁-C₁₈ alkyl or C₆-C₁₂ aryl, very preferably hydrogen, methyl, ethyl, propyl, isopropyl, n-butyl, sec-butyl, tert-butyl, phenyl, benzyl, tolyl, o-, m- or p-xylyl, 2-, 3- or 4-methoxyphenyl, 2-, 3- or 4-chloro-phenyl or 2-, 3- or 4-nitrophenyl and in particular hydrogen, methyl, ethyl, propyl, isopropyl or phenyl.

Preferably at least one of the two radicals R⁵ and R⁶ is hydrogen.

R⁷ is preferably an organic radical derived from an n-hydric alcohol by removal of n hydroxyl groups, derived for example from dihydric to decahydric alcohols, more preferably derived from dihydric to hexahydric alcohols, very preferably derived from dihydric to tetrahydric alcohols and in particular derived from dihydric to trihydric alcohols.

R₈ is preferably C₁-C₂₀ alkylene, C₃-C₁₂ cycloalkylene or C₆-C₁₂ arylene unsubstituted or substituted by halogen, C₁-C₈ alkyl, C₂-C₈ alkenyl, carboxyl, carboxy-C₁-C₈ alkyl, C₁-C₂₀ acyl, C₁-C₈ alkoxy, C₆-C₁₂ aryl, hydroxyl or hydroxy-substituted C₁-C₈ alkyl or is C₂-C₂₀ alkylene interrupted by one or more oxygen and/or sulfur atoms and/or one or more substituted or unsubstituted imino groups and/or by one or more —(CO)—, —O(CO)O—, —(NH)(CO)O—, —O(CO)(NH)—, —O(CO)—or —(CO)O— groups or is a single bond, more preferably is C₁-C₂₀ alkylene unsubstituted or substituted by halogen, C₁-C₈ alkyl, C₂-C₈ alkenyl, carboxyl, carboxy-C₁-C₈ alkyl, C₁-C₂₀ acyl, C₁-C₈ alkoxy, C₆-C₁₂ aryl, hydroxyl or hydroxy-substituted C₁-C₈ alkyl or a single bond, and very preferably is C₁-C₂₀ alkylene unsubstituted or substituted by halogen, C₁-C₈ alkyl, C₂-C₈ alkenyl, carboxyl, carboxy-C₁-C₈ alkyl, C₁-C₂₀ acyl, C₁-C₈ alkoxy, C₆-C₁₂ aryl, hydroxyl or hydroxy-substituted C₁-C₈ alkyl.

Examples of compounds (I) are methyl acrylate, ethyl acrylate, n-propyl acrylate, isopropyl acrylate, n-butyl acrylate, sec-butyl acrylate, tert-butyl acrylate, 2-ethylhexyl acrylate, 2-hydroxyethyl acrylate, 5-hydroxy-3-oxapentyl acrylate, 2-hydroxypropyl acrylate, 3-hydroxypropyl acrylate, 4-hydroxybutyl acrylate, 6-hydroxyhexyl acrylate, dihydrodicyclopentadienyl acrylate, norbornyl acrylate, cyclohexyl acrylate, cyclopentyl acrylate, cyclododecyl acrylate, phenyl acrylate, methyl crotonate, ethyl crotonate, maleic anhydride, dimethyl maleate, diethyl maleate, di-n-butyl maleate, dimethyl fumarate or diethyl fumarate.

Preferred compounds (I) are methyl acrylate, ethyl acrylate, n-propyl acrylate, isopropyl acrylate, n-butyl acrylate, sec-butyl acrylate, tert-butyl acrylate and 2-ethylhexyl acrylate.

Particularly preferred compounds (I) are methyl acrylate, ethyl acrylate, n-butyl acrylate and 2-ethylhexyl acrylate.

Examples of compounds (II) are formaldehyde, acetaldehyde, propionaldehyde, n-butyraldehyde, isobutyraldehyde, heptanal, nonanal, cyclopentylaldehyde, cyclohexylaldehyde, benzaldehyde, 3-chlorobenzaldehyde, 4-chlorobenzaldehyde, 3-hydroxybenzaldehyde, 4-hydroxybenzaldehyde, 3-methoxybenzaldehyde, 4-methyl-benzaldehyde, phenylacetaldehyde, salicylaldehyde, chloral hydrate, 4-dimethyl-aminobenzaldehyde, furfural, 2-nitrobenzaldehyde, vanillin, anisaldehyde, cinamaldehyde, pyridinecarbaldehyde, hydroxypivalaldehyde, dimethylol-propionaldehyde, dimethylolbutyraldehyde, trimethylolacetaldehyde, acetone, ethyl methyl ketone, diethyl ketone, methyl vinyl ketone, isobutyl methyl ketone, aceto-phenone, propiophenone, benzophenone, cyclopentanone, cyclohexanone or cyclododecanone.

Preferred compounds (II) are the aldehydes listed, particular preference being given to formaldehyde, acetaldehyde, propionaldehyde, n-butyraldehyde, isobutyraldehyde, benzaldehyde, 3-hydroxybenzaldehyde, 4-hydroxybenzaldehyde, hydroxypivaline-aldehyde, dimethylolpropionaldehyde, dimethylolbutyraldehyde and trimethylol-acetaldehyde and very particular preference to formaldehyde, acetaldehyde, propionaldehyde, n-butyraldehyde, isobutyraldehyde, 3-hydroxybenzaldehyde, 4-hydroxybenzaldehyde and dimethylolbutyraldehyde and especially formaldehyde.

In order to prepare rion-ether-bridged Baylis-Hillman products it is advantageous to use aldehydes in free form, i.e., to suppress the formation of formals of these aldehydes, of the formula (R⁵—CHO)_{w}, in which w is a positive integer, through the use of suitable aldehydes and/or choice of suitable solvents. Whereas in U.S. Pat. No. 5,380,901 the use of para-formaldehyde or para-formaldehyde/DMSO, in which the formation of formals is not suppressed, produces consistently ether-bridged systems, it is advantageous to use aldehydes with a high fraction of low formals, e.g., w≦20, preferably w≦10 and more preferably w≦5.

The fraction of these low formals, based on the total amount of aldehyde, ought to be for example 50%, preferably at least 60%, more preferably at least 70% and very preferably at least 80%.

In the case of formaldehyde, for example, this is achieved by using formaldehyde in the form of aqueous solutions with a concentration of, for example, not more than 49% and preferably up to 37%.

By means of these measures it is possible to lower the fraction of ether-bridged Baylis-Hillman products. This fraction is determined as the molar fraction of aldehyde equivalents in ether bridges (—CHR⁵—O—CHR⁵—) as a proportion of the total Baylis-Hillman products, i.e. ether bridges and terminal —CHR⁵OH groups.

The ether bridges therefore correspond to 2 mole equivalents of aldehyde R⁵—CHO, whereas the terminal —CHR⁵OH groups correspond to one mole equivalent of aldehyde.

The fractions of the groups can be determined, for example, via NMR spectroscopy. In the case of formaldehyde, in ¹H NMR spectra in CDCl₃, the CH₂—O—CH₂ group appears as a singlet, or as a singlet split by allyl coupling, at about δ=4.22 ppm (see U.S. Pat. No. 5,380,901) and the CH₂OH group appears at about 4.30 ppm, or in ¹³C NMR spectra in CDCl₃ the CH₂—O—CH₂ group appears at about δ=68.7 ppm and the CH₂OH group at about 62.0 ppm.

By means of the above-described measures in accordance with the invention of using aldehydes with a low fraction of formals it is possible to lower the fraction of the ether bridges generally to 50% or less, preferably to 40% or less, more preferably to not more than 33%, very preferably to not more than 25% and in particular to not more than 15%.

Contrastingly the fraction of ether bridges in the silicone diacrylate prepared in U.S. Pat. No. 5,380,901 column 5, with n=2 and 95% x=—CH₂OH (U.S. Pat. No. 5,380,901, column 5, lines 57-59) is about 69%. A high fraction of terminal OH groups, however, is advantageous in dual cure for reaction with OH-reactive groups.

Examples of compounds (IV) are ethylene glycol diacrylate, 1,2-propanediol diacrylate, 1,3-propanediol diacrylate, 1,4-butanediol diacrylate, 1,3-butanediol diacrylate, 1,5-pentanediol diacrylate, 1,6-hexanediol diacrylate, 1,8-octanediol diacrylate, neopentyl glycol diacrylate, 1,1-, 1,2-, 1,3- and 1,4-cyclohexanedimethanol diacrylate, 1,2-, 1,3- or 1,4-cyclohexanediol diacrylate, trimethylolpropane triacrylate, ditrimethylolpropane penta- or hexaacrylate, pentaerythritol tri- or tetraacrylate, glycerol di- or triacrylate, and di- and polyacrylates of sugar alcohols, such as sorbitol, mannitol, diglycerol, threitol, erythritol, adonitol (ribitol), arabitol (Iyxitol), xylitol, dulcitol (galactitol), maltitol or isomalt, or of polyester polyols, polyetherols, polyTHF with a molar mass of between 162 and 2000, poly-1,3-propanediol with a molar mass of between 134 and 1178, polyethylene glycol with a molar mass of between 106 and 898, and also urethane acrylates or polycarbonate acrylates.

Further examples are acrylates of compounds of the formula (IVa) to (IVc) 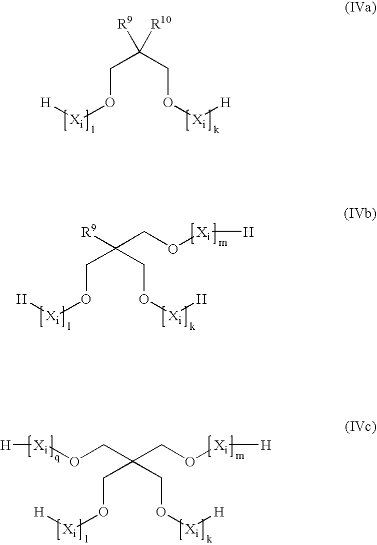
in which
R⁹ and R¹⁰ independently of one another are hydrogen or C₁-C₁₈ alkyl,
k, l, m and q independently of one another are each an integer from 1 to 10, preferably from 1 to 5 and more preferably from 1 to 3, and
each Xᵢ for i=1 to k, 1 to l, 1 to m and 1 to q can be selected, independently of the others, from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—, preferably from the group —CH₂—CH₂—O—, —CH₂—CH(CH₃)—O— and —CH(CH₃)—CH₂—O—, and more preferably —CH₂—CH₂—O—,
   in which Ph is phenyl and Vin is vinyl.

These compounds are preferably acrylates of singly to vigintuply and more preferably triply to decuply ethoxylated, propoxylated or mixedly ethoxylated and propoxylated and, in particular, exclusively ethoxylated neopentyl glycol, trimethylolopropane, trimethylolethane or pentaerythritol.

Preferred compounds (IV) are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythritol tetraacrylate, polyester polyol acrylates, polyetherol acrylates and triacrylate of singly to vigintuply ethoxylated trimethylolpropane.

Particularly preferred compounds are 1,4-butanediol diacrylate, 1,6-hexanediol diacrylate, trimethylolpropane triacrylate, pentaerythritol tetraacrylate and triacrylate of singly to vigintuply ethoxylated trimethylolpropane.

Polyester polyols are know for example from Ullmanns Encyklopädie der technischen Chemie, 4th edition, Volume 19, pp. 62 to 65. Preference is given to using polyester polyols obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples of such that may be mentioned include the following:
oxalic acid, maleic acid, fumaric acid, succinic acid, glutaric acid, adipic acid, sebacic acid, dodecanedioc acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, isomers and hydrogenation products thereof and also esterifiable derivatives, such as anhydrides or dialkyl esters, C₁-C₄ alkyl esters for example, preferably methyl, ethyl or n-butyl esters, of said acids.
   Preference is given to dicarboxylic acids of the general formula HOOC—(CH₂)_{y}—COOH, where y is a number from 1 to 20, preferably an even number for 2 to 20, more preferably to succinic acid, adipic acid, sebacic acid and dodecanedicarboxylic acid.

Polyhydric alcohols suitable for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF with a molar mass of between 162 and 2000, poly-1,3-propanediol with a molar mass of between 134 and 1178, poly-1,2-propanediol with a molar mass of between 134 and 898, polyethylene glycol with a molar mass of between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3- and 1,4-cyclohexanedimethanol, 1,2-, 1,3- or 1,4-cyclohexanediol, trimethyloibutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (Iyxitol), xylitol, dulcitol (galactitol), maltitol or isomalt.

Preferred alcohols are those of the general formula HO—(CH₂)ₓ—OH, where x is a number from 1 to 20, preferably an even number from 2 to 20. Preference is given to ethylene glycol, butane-1,4-diol, hexane-1,6-diol, octane-1,8-diol and dodecane-1,12-diol. Preference is further given to neopentyl glycol.

Also suitable are polycarbonate diols, such as may be obtained, for example, by reacting phosgene with an excess of the low molecular mass alcohols specified as synthesis components for the polyester polyols.

Also suitable are lactone-based polyester diols, which are homopolymers or copolymers of lactones, preferably hydroxy-terminal adducts of lactones with suitable difunctional starter molecules. Suitable lactones are preferably those derived from compounds of the general formula HO—(CH₂)_{z}—COOH, where z is a number from 1 to 20 and one H atom of a methylene unit may also be substituted by a C₁- to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone and also mixtures thereof. Suitable starter components are, for example, the low molecular mass dihydric alcohols specified above as a synthesis component for the polyester polyols, The corresponding polymers of ε-caprolactone are particularly preferred. Lower polyester diols or polyether diols as well can be used as starters for preparing the lactone polymers. Instead of the polymers of lactones it is also possible to use the corresponding, chemically equivalent polycondensates of the hydroxy carboxylic acids corresponding to the lactones.

Examples of compounds (VI) are glyoxal, succinaldehyde, glutaraldehyde, caproaldehyde, phthalaldehyde or terephthalaldehyde, preferably glyoxal.

The present invention further provides compounds of the formula (V) in which n is at least 3 and is preferably 3 or 4. Very particular preference is given to compounds in which the radical R⁷ is derived from optionally alkoxylated trimethylolpropane or pentaerythritol. As a result of the presence of both acrylate and hydroxyl groups, these compounds are especially suitable for dual cure. In the light of the teaching of U.S. Pat. No. 5,380,901 it is surprising that in spite of the higher density of the hydroxyl groups and their steric closeness no increased fraction of ether bridges as defined above has been found.

The implementation of the Baylis-Hillman reaction is known per se to the skilled worker and is described for example in H. M. R. Hoffmann, J. Rabe, Angew. Chem., Int. Ed. Engl., 22, 1983, 795-796 and 796-797, A. Foucaud, E. le Rouille, Synthesis, 1990, 787-789, Y. Fort, M.-C. Berthe, P. Caubere, Synthetic Communications, 1992, 22(9), 1265-1275 or D. Basaviah, P. D. Rao and R. S. Hyma, Tetrahedron, 1996, 52(24), 8001-8062.

The reaction can be carried out at a temperature between 0° C. and 100° C., preferably from 20 to 80° C. and more preferably from 25° C. to 60° C.

In order to react ketones it may be necessary to apply high pressure, as described in D. Basaviah et al, loc. cit., p. 8004.

As a catalyst for the reaction it is usual to use a tertiary amine or phosphine, such as trimethylamine, triethylamine, tri-n-butylamine, ethyldiisopropylamine, methyldiisopropylamine, N-methylmorpholine, N-methylpiperidine, triethanolamine, N,N-dimethylethanolamine, 4-dimethylaminopyridine, 1,5-diazabicyclo[4.3.0]non-5-ene (DBN), 1,8-diazabicyclo[5.4.0]undec-7-ene (DBU), pyrrocoline, quinuclidine, quinidine, trimethylphosphine, triethylphosphine, tri-n-butylphosphine, dimethylphenylphosphine, the tertiary amines or phosphines listed in D. Basaviah et al., loc. cit., pp. 8053-8054, or, preferably, 1,4-diazabicyclo[2.2.2]octane (DABCO). The catalyst is used generally in amounts from 1 to 50 mol % with respect to acrylic groups, preferably 5-50, more preferably 10-40 and very preferably 15-30 mol %.

The stoichiometry between acrylate groups and carbonyl compounds is generally 1:0.05-1.5, preferably 1:0.1-1.3, more preferably 1:0.2-1.0 and very preferably 1:0.4-1.0.

As solvents it is possible with preference to use water, petroleum ether, ligroin, toluene, benzene, xylene, tetrahydrofuran (THF), diethyl ether, dioxane, or else the acrylate used. The reaction can also be carried out in the absence of a solvent. Where the acrylate is used as solvent, the resultant reaction mixture, containing both the acrylate used and also α-(1′-hydroxyalkyl)acrylate, can be purified or used as it is, without separation of the acrylate, in which case the acrylate then acts as a reactive diluent or polyfunctional acrylate.

Purification of the reaction mixture can be omitted, although it will be appreciated that the mixture can of course also be purified by distillation, stripping, acidic, alkaline or neutral scrubbing, filtration or the like.

In one preferred embodiment the carbonyl compound is used in a substoichiometric ratio with respect to the acrylate groups, giving reaction mixtures containing the Baylis-Hillman product as a mixture with the acrylate used. Mixtures of this kind can be used with advantage in coating compositions for radiation curing and/or dual cure.

As photoinitiators (P) it is possible to use photoinitiators known to the skilled worker, examples being those referred to in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (Eds), SITA Technology Ltd, London.

In accordance with the.invention these are understood as photoinitiators which are able on exposure to light to release free radicals and to initiate a free-radical reaction: a free-radical addition polymerization, for example.

Suitable examples include phosphine oxides, benzophenones, α-hydroxyalkyl aryl ketones, thioxanthones, anthraquinones, acetophenones, benzoins and benzoin ethers, ketals, imidazoles or phenylglyoxylic acids, and mixtures thereof.

Phosphine oxides are for example monoacyl- or bisacylphosphine oxides, such as Irgacure® 819 (bis(2,4,6-trimethylbenzoyl)phenylphosphine oxide), as are described for example in EP-A 7 508, EP-A 57 474, DE-A 196 18 720, EP-A 495 751 or EP A 615 980, such as 2,4,6-trimethylbenzoyldiphenylphosphine oxide (Lucirin® TPO), ethyl 2,4,6-trimethylbenzoylphenylphosphinate or bis(2,6-dimethoxybenzoyl)-2,4,4-trimethylpentylphosphine oxide;
benzophenones are for example benzophenone, 4-aminobenzophenone, 4,4′-bis(dimethylamino)benzophenone, 4-phenylbenzophenone, 4-chlorobenzo-phenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone or 4-butoxybenzophenone;
α-hydroxyalkyl aryl ketones are for example 1-benzoylcyclohexan-1-ol (1-hydroxy-cyclohexyl phenyl ketone), 2-hydroxy-2,2-dimethylacetophenone (2-hydroxy-2-methyl-1-phenylpropan-1-one), 1-hydroxyacetophenone, 1-[4-(2-hydroxyethoxy)phenyl]-2-hydroxy-2-methyl-1-propan-1-one or polymer containing 2-hydroxy-2-methyl-1-(4-isopropen-2-ylphenyl)propan-1-one in copolymerized form (Esacure® KIP 150);
xanthones and thioxanthones are for example 10-thioxanthenone, thioxanthen-9-one, xanthen-9-one, 2,4-dimethylthioxanthone, 2,4-diethylthioxanthorie, 2,4-diisopropyl-thioxanthone, 2,4-dichlorothioxanthone or chloroxanthenone;
anthraquinones are for example β-methylanthraquinone, tert-butylanthraquinone, anthraquinonecarboxylic esters, benz[de]anthracene-7-one, benz[a]anthracene-7,12-dione, 2-methylanthraquinone, 2-ethylanthraquinone, 2-tert-butylanthraquinone, 1-chloroanthraquinone or 2-amylanthraquinone;
acetophenones are for example acetophenone, acetonaphthoquinone, valerophenone, hexanophenone, a-phenylbutyrophenone, p-morpholinopropiophenone, dibenzosuberone, 4-morpholinobenzophenone, p-diacetylbenzene, 4′-methoxy-acetophenone, α-tetralone, 9-acetylphenanthrene, 2-acetylphenanthrene, 3-acetylphenanthrene, 3-acetylindole, 9-fluorenone, 1-indanone, 1,3,4-triacetyl-benzene, 1-acetonaphthone, 2-acetonaphthone, 2,2-dimethoxy-2-phenylaceto-phenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one or 2-benzyl-2-dimethylamino-1-(4-morpholinophenyl)butan-1-one;
benzoins and benzoin ethers are for example 4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether or 7H-benzoin methyl ether; and
ketals are for example acetophenone dimethyl ketal, 2,2-diethoxyacetophenone, or benzil ketals, such as benzil dimethyl ketal.

Phenylglyoxylic acids are described for example in DE-A 198 26 712, DE-A 199 13 353 or WO 98/33761.

Photoinitiators which can be used additionally are for example benzaldehyde, methyl ethyl ketone, 1-naphthaldehyde, triphenylphosphine, tri-o-tolylphosphine or 2,3-butane-dione.

Typical mixtures include for example 2-hydroxy-2-methyl-1-phenylpropan-2-one and 1-hydroxycyclohexyl phenyl ketone, bis(2,6-dimethoxybenzoyl)-2,4,4-trimethylpentyl-phosphine oxide and 2-hydroxy-2-methyl-1-phenylpropan-1-one, benzophenone and 1-hydroxycyclohexyl phenyl ketone, bis(2,6-dimethoxybenzoyl)-2,4,4-trimethyl-pentylphosphine oxide and 1-hydroxycyclohexyl phenyl ketone, 2,4,6-trimethylbenzoyl-diphenylphosphine oxide and 2-hydroxy-2-methyl-1-phenylpropan-1-one, 2,4,6-trimethylbenzophenone and 4-methylbenzophenone or 2,4,6-trimethylbenzo-phenone, and 4-methylbenzophenone and 2,4,6-trimethylbenzoyldiphenylphosphine oxide.

Such coating compositions of the invention can be employed in accordance with the invention on radiation curing.

The coating compositions of the invention may further comprise at least one reactive diluent and/or at least one polyfunctional, polymerizable compound and/or further typical coatings additives.

Reactive diluents are, for example, esters of (meth)acrylic acid with alcohols having 1 to 20 carbon atoms, examples being methyl (meth)acrylate, ethyl (meth)acrylate, butyl (meth)acrylate, 2-ethylhexyl (meth)acrylate, 2-hydroxyethyl acrylate, 4-hydroxybutyl acrylate, dihydrodicyclopentadienyl acrylate, vinylaromatic compounds, e.g. styrene, divinylbenzene, α,β-unsaturated nitriles, e.g., acrylonitrile, methacrylonitrile, α,β-unsaturated aldehydes, e.g., acrolein, methacrolein, vinyl esters, e.g., vinyl acetate, vinyl propionate, halogenated ethylenically unsaturated compounds, e.g., vinyl chloride, vinylidene chloride, conjugated unsaturated compounds, e.g., butadiene, isoprene, chloroprene, monounsaturated compounds, e.g., ethylene, propylene, 1-butene, 2-butene, isobutene, cyclic monounsaturated compounds, e.g., cyclopentene, cyclohexene, cyclodecene, N-vinylformamide, allylacetic acid, vinylacetic acid, monoethylenically unsaturated carboxylic acids having 3 to 8 carbon atoms and their water-soluble alkali metal, alkaline earth metal or ammonium salts, such as, for example, acrylic acid, methacrylic acid, dimethylacrylic acid, ethacrylic acid, maleic acid, citraconic acid, methylenemalonic acid, crotonic acid, fumaric acid, mesaconic acid and itaconic acid, maleic acid, N-vinylpyrrolidone, N-vinyl lactams, such as N-vinylcaprolactam, N-vinyl N-alkyl carboxamides or N-vinyl carboxamides, such as N-vinylacetamide, N-vinyl-N-methylformamide and N-vinyl-N-methylacetamide, or vinyl ethers, e.g., methyl vinyl ether, ethyl vinyl ether, n-propyl vinyl ether, isopropyl vinyl ether, n-butyl vinyl ether, sec-butyl vinyl ether, isobutyl vinyl ether, terf-butyl vinyl ether, 4-hydroxybutyl vinyl ether and mixtures thereof.

(Meth)Acrylic acid in this specification stands for methacrylic acid and acrylic acid, preferably for acrylic acid.

Polyfunctional polymerizable compounds are preferably polyfunctional (meth)acrylates which carry at least 2, preferably 3-10, more preferably 3-6, very preferably 3-4 and in particular 3 (meth)acrylate groups, preferably acrylate groups.

These may be, for example, esters of (meth)acrylic acid with polyalcohols having a corresponding hydricity of at least two.

Examples of polyalcohols of this kind are at least dihydric polyols, polyetherols or polyesterols or polyacrylate polyols having an average OH functionality of at least 2, preferably from 3 to 10.

Examples of polyalcohols with a hydricity of least two are those as listed above for the preparation of the polyesterols.

Further suitable polyalcohols with a hydricity of at least two are alkoxylated polyalcohols with a hydricity of at least two, of the above-listed formulae (IVa), (IVb) or (IVc).

Examples of suitable alkylene oxides are ethylene oxide, propylene oxide, isobutylene oxide, vinyloxirane and/or styrene oxide.

The alkylene oxide chain may be composed preferably of ethylene oxide, propylene oxide and/or butylene oxide units. A chain of this kind may be composed of one species of an alkylene oxide or of a mixture of alkylene oxides. Where a mixture is used it is possible for the different alkylene oxide units to be present randomly or as a block or blocks of individual species. Preference as alkylene oxide is given to ethylene oxide, propylene oxide or a mixture thereof, particular preference to ethylene oxide or propylene oxide and very particular preference to ethylene oxide.

The number of alkylene oxide units in the chain is, for example, from 1 to 20, preferably from 1 to 10, more preferably 1-5 and in particular 1-3 and with especial preference 1, based on the respective hydroxyl groups of the polyalcohol.

Examples of suitable polyesterols include those already listed above.

The molecular weights Mₙ of the polyesterols and/or polyetherols are preferably between 100 and 4000 (Mₙ determined by gel permeation chromatography using polystyrene as standard and tetrahydrofuran as eluent).

Further possible polyfunctional (meth)acrylates may be polyester (meth)acrylates, epoxy (meth)acrylates, urethane (meth)acrylates, or (meth)acrylated polyacrylates, as listed above as acrylates of (IVa), (IVb) or (IVc). Instead of the (meth)acrylate groups it is also possible to use other free-radically or cationically polymerizable groups.

Urethane (meth)acrylates are obtainable, for example, by reacting polyisocyanates with hydroxyalkyl (meth)acrylates or hydroxyalkyl vinyl ethers and, if appropriate, chain extenders such as diols, polyols, diamines, polyamines or dithiols or polythiols.

Preferred polyfunctional (meth)acrylates are trimethylolpropane tri(meth)acrylate, (meth)acrylates of ethoxylated and/or propoxylated trimethylolpropane, pentaerythritol, glycerol or ditrimethylolpropane. Particular preference is given to acrylates of ethoxylated and/or propoxylated trimethylolpropane or pentaerythritol.

As further typical coatings additives it is possible for example to use antioxidants, stabilizers, activators (accelerators), fillers, pigments, dyes, antistats, flame retardants, thickeners, thixotropic agents, surface-active agents, viscosity modifiers, plasticizers or chelating agents.

As accelerators for the thermal after cure it is possible to use for example tin octoate, zinc octoate, dibutyltin dilaurate or diazabicyclo[2.2.2]octane.

In addition it is possible to add one or more photochemically and/or thermally activable initiators, examples being potassium peroxodisulfate, dibenzoyl peroxide, cyclohexanone peroxide, di-tert-butyl peroxide, azobisisobutyronitrile, cyclohexylsulfonyl acetyl peroxide, diisopropyl percarbonate, tert-butyl peroctoate or benzpinacol, and also, for example, those thermally activable initiators with a half-life at 80° C. of more than 100 hours, such as di-t-butyl peroxide, cumene hydroperoxide, dicumyl peroxide, t-butyl perbenzoate, silylated pinacols, such as those available commercially under the trade name ADDID 600 from Wacker, or hydroxyl-containing amine N-oxides, such as 2,2,6,6-tetramethylpiperidine-N-oxyl, 4-hydroxy-2,2,6,6-tetramethylpiperidine-N-oxyl, etc.

Other examples of suitable initiators are described in “Polymer Handbook”, 2nd ed., Wiley & Sons, New York.

Suitable thickeners besides free-radically (co)polymerized (co)polymers include customary organic and inorganic thickeners such as hydroxymethylcellulose or bentonite.

As chelating agents it is possible for example to use ethylenediamineacetic acid and its salts and also β-diketones.

Suitable fillers include silicates, e.g., silicates obtainable by hydrolysis of silicone tetrachloride, such as Aerosil® from Degussa, siliceous earth, talc, aluminum silicates, magnesium silicates, calcium carbonates, etc.

Suitable stabilizers include typical UV absorbers such as oxanilides, triazines and benzotriazole (the latter obtainable as Tinuvin® from Ciba-Spezialitätenchemie) and benzophenones. These can be used alone or together with suitable free-radical scavengers, examples of which are sterically hindered amines such as 2,2,6,6-tetramethylpiperidine, 2,6-di-tert-butylpiperidine or derivatives thereof, e.g., bis(2,2,6,6-tetramethyl-4-piperidyl) sebacinate. Stabilizers are used normally in amounts of from 0.1 to 5.0% by weight, based on the solid components present in the formulation.

The coating compositions of the invention can be used with advantage for dual-cure or multicure applications if they further comprise at least one compound (B) having at least one hydroxyl(—OH)-reactive group.

Compounds (B) having at least one hydroxyl(—OH)-reactive group may be, for example, isocyanates, including block isocyanates, epoxides, carbonates or amino resins.

Isocyanates are for example aliphatic, aromatic, and cycloaliphatic diisocyanates and polyisocyanates having an NCO functionality of at least 1.8, preferably from 1.8 to 5, and more preferably from 2 to 4, and also their isocyanurates, biurets, urethanes, allophanates, and uretdiones.

The diisocyanates are preferably isocyanates having 4 to 20 carbon atoms. Examples of common diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone.diisocyanate), 1,3- or 1,4-bis(isocyanatomethyl)cyclohexane or 2,4-, or 2,6-diisocyanato-1-methylcyclohexane and also aromatic diisocyanates such as 2,4- or 2,6-tolylene diisocyanate and the isomer mixtures thereof, m- or p-xylylene diisocyanate, 2,4′- or 4,4′-diisocyanatodiphenylmethane and the isomer mixtures thereof, 1,3- or 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyidiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Suitable polyisocyanates include polyisocyanates containing isocyanurate groups, uretdione diisocyanates, polyisocyanates containing biuret groups, polyisocyanates containing urethane or allophanate groups, polyisocyanates containing oxadiazinetrione or iminooxadiazinedione groups, uretonimine-modified polyisocyanates of straight-chain or branched C4-C20 alkylene diisocyanates, cycloaliphatic diisocyanates having 6 to 20 carbon atoms in all or aromatic diisocyanates having 8 to 20 carbon atoms in all, or mixtures thereof.

The diisocyanates and polyisocyanates which can be used preferably have an isocyanate group content (calculated as NCO, molecular weight=42) of from 10 to 60% by weight, based on the diisocyanate and polyisocyanate (mixture), more preferably from 15 to 60% by weight, and very preferably from 20 to 55% by weight.

Preference is given to aliphatic and/or cycloaliphatic diisocyanates and polyisocyanates, examples being the aliphatic and cycloaliphatic diisocyanates, respectively, that have been mentioned above, or to mixtures thereof.

Hexamethylene diisocyanate, 1,3-bis(isocyanatomethyl)cyclohexane, isophorone diisocyanate, and di(isocyanatocyclohexyl)methane, are particularly preferred, isophorone diisocyanate and hexamethylene diisocyanate are very particularly preferred, and hexamethylene diisocyanate is especially preferred.

Preference is extended to
1) polyisocyanates containing isocyanurate groups and derived from aromatic, aliphatic and/or cycloaliphatic diisocyanates. Particularly preferred here are the corresponding aliphatic and/or cycloaliphatic isocyanato isocyanurates and in particular those based on hexamethylene diisocyanate and isophorone diisocyanate. The isocyanurates present are, in particular, trisisocyanatoalkyl or trisisocyanatocycloalkyl isocyanurates, which constitute cyclic trimers of the diisocyanates, or mixtures with their higher homologs containing more than one isocyanurate ring. The isocyanato isocyanurates generally have an NCO content of from 10 to 30% by weight, in particular from 15 to 25% by weight, and an average NCO functionality of from 2.6 to 4.5.
2) Uretdione diisocyanates having aromatically, aliphatically and/or cycloaliphatically attached isocyanate groups, preferably aliphatically and/or cycloaliphatically attached groups, and in particular those derived from hexamethylene diisocyanate or isophorone diisocyanate. Uretdione diisocyanates are cyclic dimerization products of diisocyanates.

In the formulations of the invention the uretdione diisocyanates can be used as a component alone or in a mixture with other polyisocyanates, particularly those specified under 1).
3) Polyisocyanates containing biuret groups and having aromatically, cycloaliphatically or aliphatically, preferably cycloaliphatically or aliphatically, attached isocyanate groups, especially tris(6-isocyanatohexyl)biuret or its mixtures with its higher homologs. These polyisocyanates containing biuret groups generally have an NCO content of from 18 to 22% by weight and an average NCO functionality of from 2.8 to 4.5.
4) Polyisocyanates containing urethane and/or allophanate groups and aromatically, aliphatically or cycloaliphatically, preferably aliphatically or cycloaliphatically, attached isocyanate groups, as are obtainable for example by reacting excess amounts of hexamethylene diisocyanate or of isophorone diisocyanate with monohydric or polyhydric alcohols such as methanol, ethanol, isopropanol, n-propanol, n-butanol, iso-butanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol or polyhydric alcohols as listed above for the polyesterols, or mixtures thereof. These polyisocyanates containing urethane and/or allophanate groups generally have an NCO content of from 12 to 20% by weight and an average NCO functionality of from 2.5 to 4.5.
5) Polyisocyanates containing oxadiazinetrione groups, preferably derived from hexamethylene diisocyanate or isophorone diisocyanate. Polyisocyanates of this kind containing oxadiazinetrione groups can be prepared from diisocyanate and carbon dioxide.
6) Polyisocyanates containing iminooxadiazinedione groups, preferably derived from hexamethylene diisocyanate or isophorone diisocyanate. Polyisocyanates of this kind containing iminooxadiazinedione groups can be prepared from diisocyanates by means of specific catalysts.
7) Uretonimine-modified polyisocyanates.

Polyisocyanates 1) to 7) can be used in a mixture, including where appropriate a mixture with diisocyanates.

The isocyanate groups may also be in blocked form. Examples of suitable blocking agents for NCO groups include oximes, phenols, imidazoles, pyrazoles, pyrazolinones, diketopiperazines, caprolactams, malonic esters or compounds as specified in the publications by Z. W. Wicks, Prog. Org. Coat. 3 (1975) 73-99 and Prog. Org. Coat 9 (1981), 3-28 and also in Houben-Weyl, Methoden der Organischen Chemie, Vol. XIV/2, 61 ff. Georg Thieme Verlag, Stuttgart 1963.

By blocking agents or capping agents in this context are meant compounds which convert isocyanate groups into blocked (capped or protected) isocyanate groups which subsequently, below the temperature known as the deblocking temperature, do not exhibit the usual reactions of a free isocyanate group. Compounds of this kind containing blocked isocyanate groups are commonly employed in dual-cured coating materials whose curing is completed via isocyanate group curing.

Epoxide compounds are those containing at least one, preferably containing at least two, preferably two or three, epoxide group(s) in the molecule.

Suitable examples include epoxidized olefins, glycidyl esters (e.g, glycidyl (meth)acrylate) of saturated or unsaturated carboxylic acids or glycidyl ethers of aliphatic or aromatic polyols. Products of this kind are offered commerically in large numbers. Particular preference is given to golyglycidyl compounds of the bisphenol A, F or B type and glycidyl ethere of polyfunctional alcohols, e.g., of butanediol, of 1,6-hexandiol, of glycerol and of pentaerythritol. Examples of such polyepoxide compounds are Epikotes® 812 (epoxide value: about 0.67 mol/100 g) and Epikote® 828 (epoxide value: about 0.53 mol/100 g), Epikote® 1001, Epikote® 1007 and Epikote® 162 (epoxide value: about 0.61 mol/100 g) from Resolution, Rütapox® 0162 (epoxide value: about 0.58 mol/100 g), Rütapox® 0164 (epoxide value: about 0.53 mol/100 g) and Rütapox® 0165 (epoxide value: about 0.48 mol/100 g) from Bakelite AG, and Araldit® DY 0397 (epoxide value: about 0.83 mol/100 g) from Vantico AG.

Carbonate compounds are those containing at least one, preferably containing at least two, preferably two or three, carbonate group(s) in the molecule, containing preferably terminal C₁-C₂₀ alkyl carbonate groups, more preferably terminal C₁-C₄ alkyl carbonate groups, very preferably terminal methyl carbonate, ethyl carbonate or n-butyl carbonate.

Suitable components (B) further include compounds containing active methylol or alkylalkoxy groups, especially methylalkoxy groups, amino resin crosslinkers, such as etherified reaction products of formaldehyde with amines, such as melamine, urea, etc., phenol/formaldehyde adducts, siloxane or silane groups and anhydrides, as described for example in U.S. Pat. No. 5,770,650.

Among the preferred amino resins, which are known and wide spread industrially, it is possible with particular preference to use urea resins and melamine resins, such as urea-formaldehyde resins, melamine-formaldehyde resins, melamine-phenol-formaldehyde resins or melamine-urea-formaldehyde resins, for example.

Suitable urea resins are those which are obtainable by reacting ureas with aldehydes and which if appropriate can be modified.

Suitable ureas include urea and N-substituted or N,N′-disubstituted ureas, such as N-methylurea, N-phenylurea, N,N′-dimethylurea, hexamethylenediurea, N,N′-diphenylurea, 1,2-ethylenediurea, 1,3-propylenediurea, diethylenetriurea, dipropylenetriurea, 2-hydroxypropylenediurea, 2-imidazolidinone (ethyleneurea), 2-oxohexahydropyrimidine (propyleneurea) or 2-oxo-5-hydroxyhexahydropyrimidine (5-hydroxypropyleneurea).

Urea resins can if appropriate be partly or fully modified, for example by reaction with monofunctional or polyfunctional alcohols, ammonia and/or amines (cationically modified urea resins) or with (hydrogen)sulfites (anionically modified urea resins), particular suitability being possessed by the alcohol-modified urea resins.

Suitable alcohols for the modification include C₁-C₆ alcohols, preferably C₁-C₄ alcohol and in particular methanol, ethanol, isopropanal, n-propanol, n-butanol, isobutanol and sec-butanol.

Suitable melamine resins are those which are obtainable by reacting melamine with aldehydes and which if appropriate may be partly or fully modified.

Particularly suitable aldehydes include formaldehyde, acetaldehyde, isobutyraldehyde and glyoxal.

Melamine-formaldehyde resins are reaction products from the reaction of melamine with aldehydes, examples being the aforementioned aldehydes, especially formaldehyde. If appropriate the resultant methylol groups are modified by etherification with the abovementioned monohydric or polyhydric alcohols. It is also possible for the melamine-formaldehyde resins to be modified as described above by reaction with amines, amino carboxylic acids or sulfites.

The action of formaldehyde on mixtures of melamine and urea or on mixtures of melamine and phenol produces melamine-urea-formaldehyde resins or, respectively melamine-phenol-formaldehyde resins which can likewise be used in accordance with the invention.

The amino resins referred to are prepared by methods known per se.

Examples mentioned particularly are melamine-formaldehyde resins, including monomeric or polymeric melamine resins and partly or fully alkylated melamine resins, urea resins, e.g., methylolureas such as formaldehyde-urea resins, alkoxyureas such as butylated formaldehyde-urea resins, but also N-methylolacrylamide emulsions, isobutoxymethylacrylamide emulsions, polyanhydrides, such as polysuccinic anhydride, and siloxanes or silanes, e.g., dimethyldimethoxysilanes.

Particular preference is given to amino resins such as melamine-formaldehyde resins or formaldehyde-urea resins.

Likewise disclosed is a method of coating substrates using a coating composition of the invention.

The coating of the substrates is in accordance with customary methods which are known to the skilled worker, in which at least one coating composition of the invention or coating formulation comprising it is applied to the target substrate in the desired thickness and the volatile constituents of the coating composition are removed, where appropriate with heating. This operation can be repeated one or more times if desired. Application to the substrate may take place in a known way, for example, by spraying, troweling, knifecoating, brushing, rolling, roller coating or pouring. The coating thickness is generally in a range from about 3 to 1000 g/m² and preferably from 10 to 200 g/m².

Disclosed in addition is a method of coating substrates which involves adding further typical coatings additives and thermally curable resins where appropriate to the coating compositions of the invention or to coating formulations comprising them, applying the resultant systems to the substrate, and drying them where appropriate, and curing them with electron beams or by UV exposure under an oxygen-containing atmosphere or preferably under inert gas, where appropriate at temperatures up to the level of the drying temperature, and subsequently subjecting them to thermal treatment at temperatures up to 160° C., preferably between 60 and 160° C.

The method of coating substrates can also be conducted such that application of the inventive coating composition or coating formulations is followed first by their thermal treatment at temperatures up to 160° C., preferably between 60 and 160° C., and subsequently by curing with electron beams or by UV exposure under oxygen or preferably under inert gas.

Curing of the films formed on the substrate can if desired take place by means of heat alone. Generally speaking and preferably, however, the coatings are cured both by exposure to high-energy radiation and thermally.

If two or more coats of the coating material are applied one above another it is possible if desired for each coating operation to be followed by a thermal and/or radiation cure.

Examples of suitable radiation sources for the radiation cure include low pressure mercury lamps, medium pressure mercury lamps, and high pressure mercury lamps, and. also fluorescent tubes, pulsed lamps, metal halide lamps, electronic flash devices, which allow radiation curing without a photoinitiator, or excimer emitters. The radiation cure is effected by-exposure to high-energy radiation, i.e., UV radiation or daylight, preferably light in the wavelength (λ) range of 200 to 700 nm, more preferably 200 to 500 nm, and very preferably 250 to 400 nm, or by irradiation with high-energy electrons (electron beams; 150 to 300 keV). Radiation sources used are for example high pressure mercury vapor lamps, lasers, pulsed lamps (flashlight), halogen lamps or excimer emitters. The radiation dose normally sufficient for crosslinking in the case of UV curing is in the range from 80 to 3000 mJ/cm².

It is of course also possible to use two or more radiation sources for curing, e.g., two to four.

The sources may also each emit in different wavelength ranges.

In addition to or instead of the thermal cure, curing may also be effected by means of NIR radiation, which here means electromagnetic radiation in the wavelength range from 760 nm to 2.5 μm, preferably from 900 to 1500 nm.

Where appropriate, irradiation can also be carried out in the absence of oxygen, e.g., under an inert gas atmosphere. Suitable inert gases include preferably nitrogen, noble gases, carbon dioxide, or combustion gases. Irradiation may also be performed with the coating composition covered with transparent media. Examples of transparent media are polymer films, glass or liquids, e.g., water. Particular preference is given to irradiation in the manner described in DE-A1 199 57 900.

The invention further provides a method of coating substrates which comprises
i) coating a substrate with a coating composition as described above,
ii) removing volatile constituents of the-coating composition in order to form a film, under conditions in which the initiator (P) as yet essentially forms no free radicals,
iii) if desired, subjecting the film formed in step ii) to high-energy radiation, in the course of which the film is precured, and subsequently machining the article coated with the precured film, if desired, or contacting the surface of the precured film with another substrate, and
iv) subjecting the film to a final thermal cure.

Steps iv) and iii) may also be carried out in the opposite order, i.e., the film can be cured first thermally and then with high-energy radiation.

The coating compositions and formulations of the invention are particularly suitable for the coating of substrates such as wood, paper, textile, leather, nonwoven, plastics surfaces, glass, ceramic, mineral building materials, such as cement blocks and fiber cement slabs, or coated or uncoated metals, preferably for the coating of plastics or metals, possibly in the form of films or foils, for example.

With particular preference the coating compositions of the invention are suitable as or in exterior coatings, i.e., in those applications where they are exposed to daylight, preferably on buildings or parts of buildings, interior coatings, traffic markings, coatings on vehicles or aircraft. The coating compositions of the invention are employed in particular as or in automotive clearcoat and topcoat material(s).

The invention further provides for the use of α-(1′-hydroxyalkyl)acrylates in coating compositions for dual-cure applications.

The invention further provides for the use of compounds of the formula (V) or (VII) in radiation curing.

The examples which follow are intended to illustrate the properties of the invention, though without restricting it.

### EXAMPLES

Parts or percent in this specification, unless otherwise indicated, are to be understood as parts by weight or percent by weight.

The Erichsen cupping was determined in accordance with DIN 53156 and is a measure of the flexibility and elasticity. It is reported in millimeters (mm). High values denote high flexibility. For determining the Erichsen cupping, the films were—unless specified otherwise—applied to sheet metal using a spiral-wound wire doctor. The film thickness after exposure, unless specified otherwise, was 40 μm.

The pendulum hardness was determined in accordance with DIN 53157 and is a measure of the hardness of the coating. It is reported in seconds (s). High values denote high hardness. For determination of the pendulum hardness, the films—unless otherwise specified—were applied to glass using a box-type doctor. The film thickness after exposure, unless specified otherwise, was 70 μm.

The OH number was determined in accordance with DIN 53240.

### Example 1

148 parts of trimethylolpropane triacrylate, 17 parts of diazabicyclooctane, 100 parts of tetrahydrofuran and 150 parts of formaldehyde solution (36% strength) were combined in a reaction flask and stirred at 60° C. for 2 hours.

Then 100 parts of diethyl ether were added, the mixture was extracted by shaking twice with 100 parts of 1N hydrochloric acid and once with aqueous sodium chloride solution, the phases were separated, the organic phase was dried over sodium sulphate, 1 part of phenothiazine was added and the solvent was removed by distillation.

This gave a clear, pale yellowish liquid which in the IR spectrum showed a distinct OH band at 3500 cm⁻¹ (OH number 109 mg KOH/g) and a shift of the unsubstituted acrylate band at 810 cm⁻¹ to 820 cm⁻¹. In the GC chromatogram there was no longer any free trimethylolpropane triacrylate.

### Example 2

148 parts of trimethylolpropane triacrylate, 5.6 parts of diazabicyclooctane, 100 parts of tetrahydrofuran and 50 parts of formaldehyde solution (36% strength) were combined in a reaction flask and stirred at 60° C. for 2 hours.

Then 100 parts of diethyl ether were added, the mixture was extracted by shaking twice with 100 parts of 1N hydrochloric acid and once with aqueous sodium chloride solution, the phases were separated, the organic phase was dried over sodium sulphate, 1 part of phenothiazine was added and the solvent was removed by distillation.

This gave a clear liquid having a viscosity of 510 mPas, which in the IR spectrum showed a distinct OH band at 3500 cm⁻¹ (OH number 63 mg KOH/g). In the GC chromatogram there was still 23 area-percent of free trimethylolpropane triacrylate.

### Example 3

302 parts of triacrylate of septuply ethoxylated trimethylolpropane, 17 parts of diazabicyclooctane, 100 parts of tetrahydrofuran and 150 parts of formaldehyde solution (36% strength) were combined in a reaction flask and stirred at 60° C. for 2 hours.

Then 100 parts of diethyl ether were added, the mixture was extracted by shaking twice with 100 parts of 1N hydrochloric acid and once with aqueous sodium chloride solution, the phases were separated, the organic phase was dried over sodium sulphate, 1 part of phenothiazine was added and the solvent was removed by distillation.

This gave a clear, pale yellowish liquid which in the IR spectrum showed a distinct OH band at 3500 cm⁻¹.

### Example 4

500 parts of a commercially available polyester acrylate (Laromer® PE 55F, BASF Aktiengesellschaft), 14 parts of diazabicyclooctane, 100 parts of tetrahydrofuran and 125 parts of formaldehyde solution (36% strength) are combined in a reaction flask and stirred at 60° C. for 2 hours.

Then 100 parts of diethyl ether are added, the mixture is extracted by shaking twice with 100 parts of 1N hydrochloric acid and once with aqueous sodium chloride solution, the phases are separated, the organic phase is dried over sodium sulphate, 1 part of phenothiazine is added and the solvent is removed by distillation.

This gives a clear, pale yellowish liquid which in the IR spectrum shows a distinct OH band at 3500 cm⁻¹.

### Example 5

215 parts of a commercially available epoxy acrylate (Laromer® EA 81, BASF Aktiengesellschaft), 11 parts of diazabicyclooctane, 100 parts of tetrahydrofuran and 100 parts of formaldehyde solution (36% strength) are combined in a reaction flask and stirred at 60° C. for 2 hours.

Then 100 parts of diethyl ether are added, the mixture is extracted by shaking twice with 100 parts of 1N hydrochloric acid and once with aqueous sodium chloride solution, the phases are separated, the organic phase is dried over sodium sulphate, 1 part of phenothiazine is added and the solvent is removed by distillation.

This gives a clear, pale yellowish liquid which in the IR spectrum shows a distinctly increased OH band at 3500 cm⁻¹ as compared with the starting compound.

### Example 6

750 parts of a commercially available urethane acrylate (Laromer® UA195, BASF Aktiengesellschaft), 11 parts of diazabicyclooctane, 100 parts of tetrahydrofuran and 11 parts of formaldehyde solution (36% strength) are combined in a reaction flask and stirred at 60° C. for 2 hours.

Then 100 parts of diethyl ether are added, the mixture is extracted by shaking twice with 100 parts of 1N hydrochloric acid and once with aqueous sodium chloride solution, the phases are separated, the organic phase is dried over sodium sulphate, 1 part of phenothiazine is added and the solvent is removed by distillation.

This gives a clear, pale yellowish liquid which in the IR spectrum shows in addition to the NH band a distinct OH band at 3500 cm⁻¹.

### Example 7

### Dual-Cure Application

10 parts of the α-hydroxyalkyl acrylate prepared according to example 1 were mixed with 3.8 parts of a trimeric isocyanurate of hexamethylene diisocyanate and the mixture was applied in a film thickness of about 5 μm to a KBr disk for IR. The IR spectrum showed the OH bands at 3500 cm⁻¹, the NCO bands at 2250 cm⁻¹ and the acrylate bands at 820 cm⁻¹. When the IR crystal was heated at 180° C. for 2 hours the NCO band at 2250 cm⁻¹ disappeared almost completely, the acrylate band underwent a reduction and the OH band had shifted to 3350 cm⁻¹ (NH). Subsequent exposure caused the acrylate band as well to disappear almost completely.

Similar results were obtained by exposing first and then heating at 180° C.

### Example 8

10 parts of the a-hydroxyalkyl acrylate prepared according to example 1 were admixed with 0.4 part of the photoinitiator Darocure® 1173 (CIBA Specialties) and the mixture was applied to a glass plate in a film thickness of approximately 50 μm and exposed with 1200 mJ/cm². This gave a pendulum hardness of 140 s and an Erichsen cupping of 0.5 mm.

### Comparative Example 1

Using the same conditions as in example 8, trimethylolpropane triacrylate, instead of the reaction product from example 1, was processed. This gave a pendulum hardness of 172 s and an Erichsen cupping of 0.

Example 8 and comparative example 1 show that with the α-hydroxy acrylates of the invention similar properties after UV exposure, in respect of hardness and flexibility, are obtained as with unsubstituted acrylate, and example 7 shows that dual-cure coating materials can be prepared with the products of the invention.

1. A compound of the formula (V), 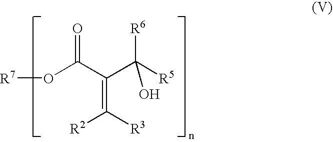
in which
R² and R³ independently of one another are C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles,
R² and/or R³ are/is additionally hydrogen, C₁-C₁₈ alkoxy optionally substituted by aryl, alkyl, aryloxy, alkyloxy, heteroatoms and/or heterocycles, or —COOR⁴,
R² may additionally together with R¹ form a ring, in which case R² can be a carbonyl group, so that the group COOR¹ and R² together form an acid anhydride group —(CO)—O—(CO)—,
R⁴ is C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles,
R⁵ and R⁶ independently of one another are hydrogen, C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles, or may together form a ring,
n is a positive integer from 3 to 10, and
R⁷ is an n-valent organic radical having 1 to 50 carbon atoms which can be unsubstituted or substituted by halogen, C₁-C₈ alkyl, C₂-C₈ alkenyl, carboxyl, carboxy-C₁-C₈ alkyl, C₁-C₂₀ acyl, C₁-C₈ alkoxy, C₆-C₁₂ aryl, hydroxyl or hydroxy-substituted C₁-C₈ alkyl and/or can contain one or more —(CO)—, —O(CO)O—, —(NH)(CO)O—, —O(CO)(NH)—, —O(CO)— or —(CO)O— groups.

2. The compound according to claim 1, wherein n is 3 or 4 and
R⁷ is derived from an n-hydric alcohol by removing n hydroxyl groups, the n-hydric alcohol being trimethylolpropane, pentaerythritol or a singly to vigintuply ethoxylated trimethylolpropane.

3. A coating composition comprising
at least one compound of the formula (V) as defined in claim 1, or of the formula (VII) 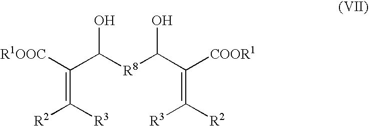
in which R² and R² are as defined;
R² and R³ are/is additionally hydrogen, C₁-C₁₈ alkoxy optionally substituted by aryl, alkyl, aryloxy, alkyloxy, heteroatoms and/or heterocycles, or —COOR⁴,
R² may additionally together with R¹ form a ring, in which case R² can be a carbonyl group, so that the group COOR¹ and R² together form an acid anhydride group —(CO)—O—(CO)—,
R⁴ is C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles,
R¹ is C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles,
R⁸ is unsubstituted or halogen-, C₁-C₈ alkyl-, C₂-C₈ alkenyl-, carboxyl-, carboxy-C₁-C₈ alkyl-, C₁-C₂₀ acyl-, C₁-C₈ alkoxy-, C₆-C₁₂ aryl-, hydroxyl- or hydroxy-substituted C₁-C₈ alkyl-substituted C₆-C₁₂ arylene, C₃-C₁₂ cycloalkylene or C₁-C₂₀ alkylene or is C₂-C₂₀ alkylene interrupted by one or more oxygen and/or sulfur atoms and/or one or more substituted or unsubstituted imino groups and/or by one or more —(CO)—, —O(CO)O—, —(NH)(CO)O—, —O(CO)(NH)—, —O(CO)— or —(CO)O— groups or is a single bond, and
at least one photoinitiator (P).

4. The coating composition according to claim 3, further comprising
at least one reactive diluent and/or
at least one polyfunctional polymerizable compound.

5. The coating composition according to claim 3, further comprising
at least one compound (B) containing at least one hydroxy (—OH)-reactive group.

6. A method of coating substrates comprising applying a coating composition according to claim 3.

7. A substrate coated with a coating composition according to claim 3.

8. A process for preparing a compound of the formula (V) as defined in claim 1 and according to the process formulation: 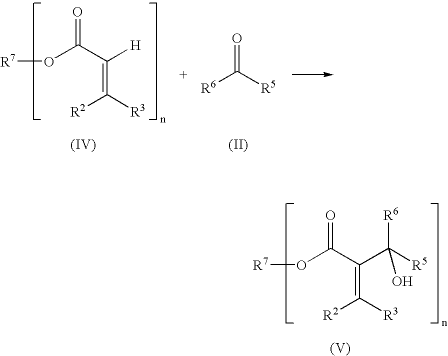
in which n is a positive integer from 2 to 10, wherein the compound (II) is an aldehyde R⁵—CHO and is used in free form so that in formals of the formula (R⁵—CHO)_{w,} in which w is a positive integer, w is ≦20.

9. The method of using in coating compositions for dual-cure applications α-(1′-hydroxyalkyl)acrylates.

10. The method of using in radiation curing compounds of the formula (V) as defined in claim 8 or (VII) 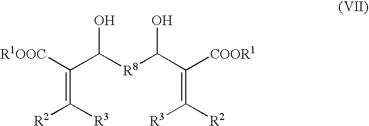
in which
R¹ is C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles,
R² and R³ independently of one another are C₁-C₁₈ alkyl, C₂-C₁₈ alkyl if appropriate interrupted by one or more oxygen and/or sulfur atoms and/or one or more substituted or unsubstituted imino groups, C₂-C₁₈ alkenyl, C₆-C₁₂ aryl, C₅-C₁₂ cycloalkyl or a five- to six-membered oxygen-, nitrogen- and/or sulfur-containing heterocycle, it being possible for each of the stated radicals to be substituted by aryl, alkyl, aryloxy, alkyloxy, heteroatoms and/or heterocycles,
R² and/or R³ are/is additionally hydrogen, C₁-C₁₈ alkoxy optionally substituted by aryl, alkyl, aryloxy, alkyloxy, heteroatoms and/or heterocycles, or —COOR⁴,
R² may additionally together with R¹ form a ring, in which case R² can be a carbonyl group, so that the group COOR¹ and R² together form an acid anhydride group —(CO)—O—(CO)—, and
R⁸ is unsubstituted or halogen-, C₁-C₈ alkyl-, C₂-C₈ alkenyl-, carboxyl-, carboxy-C₁-C₈ alkyl-, C₁-C₂₀ acyl-, C₁-C₈ alkoxy-, C₆-C₁₂ aryl-, hydroxyl- or hydroxy-substituted C₁-C₈ alkyl-substituted C₆-C₁₂ arylene, C₃-C₁₂ cycloalkylene or C₁-C₂₀ alkylene or is C₂-C₂₀ alkylene interrupted by one or more oxygen and/or sulfur atoms and/or one or more substituted or unsubstituted imino groups and/or by one or more —(CO)—, —O(CO)O—, —(NH)(CO)O—, —O(CO)(NH)—, —O(CO)— or —(CO)O— groups or is a single bond.
